(19) United States
(12) Patent Application Publication
(10) Pub. No.: US 2024/0335801 A1
(43) Pub. Date: Oct. 10, 2024

(54) SYSTEM AND METHOD FOR AIRLESS AQUEOUS IODINE PRODUCTION

(71) Applicant: NOVO INTEGRATED SCIENCES INC., Bellevue, WA (US)

(72) Inventor: Terence Francis Mullins, Magog (CA)

(21) Appl. No.: 18/291,786

(22) PCT Filed: Mar. 2, 2022
(86) PCT No.: PCT/IB2022/051858

§ 371 Date: Jan. 24, 2024

Related U.S. Application Data
(60) Provisional application No. 63/225,790, filed on Jul. 26, 2021.

(51) Int. Cl. B01F 23/40; B01F 21/20; B01F 25/30; B01F 35/21; B01F 35/22

(52) U.S. Cl. CPC B01F 23/483; B01F 21/20; B01F 25/30; B01F 35/21112; B01F 35/2132; B01F 35/2202

(57) ABSTRACT

A system and method are provided for airless aqueous iodine production. The system includes a water feed line to iodine columns, an iodine concentrate supply line from the iodine columns with a sensor for measuring iodine concentration, a finished aqueous iodine supply line with an inline mixer for mixing the iodine concentrate with water from a water bypass line to produce a finished aqueous iodine. A programmable logic controller is connected to water feed line valve, iodine concentrate supply line valve and the sensor for controlling iodine concentration. The method includes flowing water through iodine columns to produce an iodine concentrate, filtering the iodine concentrate, measuring iodine concentration using a sensor, adjusting iodine concentration with water from a water bypass line, passing the aqueous iodine through a manifold that includes a vacuum system to an airless iodine product reservoir to produce airless aqueous iodine.

### FIELD

The present disclosure relates to aqueous iodine, and more particularly to a system and method for high output production of airless aqueous iodine.

### BACKGROUND

In aqueous iodine generation, it is difficult to control the precise iodine levels within a solution due to environmental conditions. Current iodine generators require a “series structured” water flow dynamic with multiple generators running from one to another to increase flow rates. Alternatively, current iodine generators utilize a high iodine content, inefficient, single iodine generator.

Typically, iodine generators are purpose or application designed to provide a blending of water to iodine concentrate to produce low concentrations of iodine in an aqueous iodine water supply under dynamic flow conditions.

What is lacking in the field is an efficient aqueous iodine generator that provides high output and accurate target concentrations of aqueous iodine.

### SUMMARY

In the present disclosure, a system and method for high output and accurate production of airless aqueous iodine is provided.

Thus by one broad aspect of the present invention, a system is provided for airless aqueous iodine production. The system includes a plurality of iodine columns to hold iodine, a water feed line connected through a water feed line valve to the iodine columns, for providing water to the iodine columns, a water by-pass line having a first end and a second end, the first end diverting from the water feed line, for diverting water away from the water feed line and the second end connected to a finished aqueous iodine supply line, for supplying water to the finished aqueous iodine supply line. At least one iodine concentrate supply line is connected through an iodine concentrate supply line valve to at least one of the iodine columns, for directing iodine concentrate from the iodine column to the finished aqueous iodine supply line. The iodine concentrate supply line includes a sensor for measuring iodine concentration. The finished aqueous iodine supply line includes a first end connected to the iodine concentrate supply line and the water bypass line, an inline mixer for mixing the iodine concentrate with the water from the water bypass line to produce a finished aqueous iodine, and a second end. A manifold has a first end connected to the second end of the finished aqueous iodine supply line through a finished aqueous iodine supply line valve, a second end connected to an airless iodine product reservoir, for storing the airless aqueous iodine, and a vacuum system to remove air from the finished aqueous iodine. A programmable logic controller is connected to the water feed line valve, the iodine concentrate supply line valve, and the sensor, for controlling the valves in response to measurements from the sensor.

By a further aspect of the present invention, a method is provided for producing airless aqueous iodine. The method includes providing water through a water feed line to a plurality of iodine columns, flowing water through the plurality of iodine columns to produce an iodine concentrate, passing the iodine concentrate through an iodine concentrate supply line, filtering the iodine concentrate through a sediment filter, measuring an iodine concentration of the iodine concentrate using a sensor, adjusting the iodine concentration of the iodine concentrate with water from a water bypass line to produce an aqueous iodine, passing the aqueous iodine through a manifold that includes a vacuum system to produce an airless aqueous iodine, and passing the airless aqueous iodine to an airless iodine product reservoir for storage.

A further understanding of the functional and advantageous aspects of the invention can be realized by reference to the following detailed description and drawings.

### BRIEF DESCRIPTION OF THE DRAWINGS

Embodiments disclosed herein will be more fully understood from the following detailed description taken in connection with the accompanying drawings, which form a part of this application, and in which:

FIG. 1 is a schematic representation of a system for airless aqueous iodine production, according to an embodiment of the present disclosure.

FIG. 2 is a continuation of the schematic representation of FIG. 1, illustrating a bottling system for the airless aqueous iodine production system according to the embodiment of FIG. 1.

### DETAILED DESCRIPTION

The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although the invention has been described with a preferred embodiment, it should be noted that the inventor can make various modifications, additions and alterations to the invention without departing from the original scope as described in the present disclosure.

A system for airless aqueous iodine production is provided herein that overcomes the limitations of current iodine generators. The system provides precise aqueous iodine production and dosing with inline assessment and automated regulation of iodine content. The system further provides containment and bottling of finished batch aqueous iodine to maintain the iodine concentration.

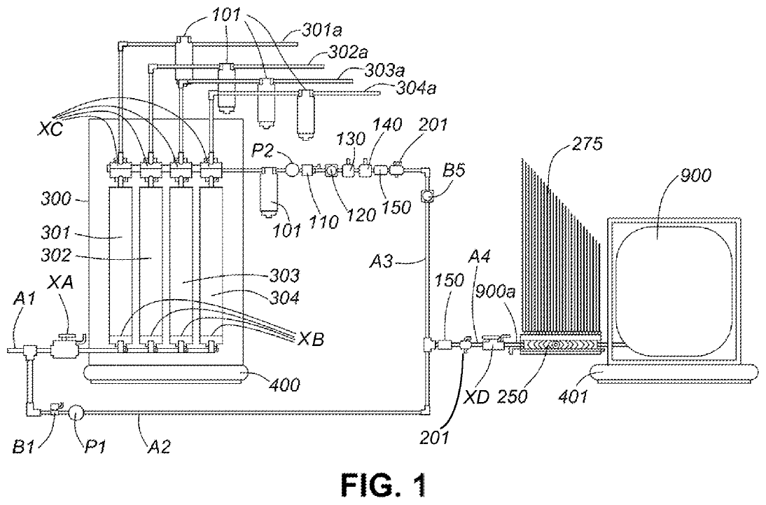

Referring to FIG. 1, an embodiment of the system for airless aqueous iodine production is shown and includes a plurality of iodine columns 301, 302, 303, 304 to hold iodine. A water feed line A1, connected through a water feed line valve XA, provides water to the iodine columns 301, 302, 303, 304. Additional iodine column valves XB control the water flow for each iodine column 301, 302, 303, 304. A water by-pass line A2 diverts water away from the water feed line A1, bypassing the iodine columns 301, 302, 303, 304, to connect and supply water to a finished aqueous iodine supply line A4, described below.

An iodine concentrate supply line A3 is connected to the iodine columns 301, 302, 303, 304 through an iodine concentrate supply line valve XC, and carries iodine concentrate from the iodine columns 301, 302, 303, 304 to the finished aqueous iodine supply line A4. The iodine concentrate supply line A3 includes a sensor 110, 120 for measuring the iodine concentration in the iodine concentrate.

Both the iodine concentrate supply line A3 and the water by-pass line A2 connect to a first end of the finished aqueous iodine supply line A4. An inline mixer 150 in the finished aqueous iodine supply line A4 mixes the iodine concentrate with the water from the water bypass line A2 to produce a finished aqueous iodine.

A second end of the finished aqueous iodine supply line A4 is connected to a manifold 250 through a finished aqueous iodine supply line valve XD. The other end of the manifold 250 is connected to an airless iodine product reservoir 900, for storing the airless aqueous iodine. A vacuum system 900a connected to the manifold 250 removes air from the iodine product reservoir 900.

A programmable logic controller 999 is connected to the water feed line valve XA, the iodine column valves XB, the iodine concentrate supply line valve XC and the sensor 110, 120, and controls the valves XA, XB, XC in response to measurements from the sensor 110, 120, thereby regulating the production and concentration of the finished aqueous iodine.

In an embodiment, an iodine generator box 300 supports the iodine columns 301, 302, 303, 304. An iodine generator scale 400 is connected to the iodine generator box 300, and measures the weight of the iodine in the iodine columns 301, 302, 303, 304. The weight measurement from the iodine generator scale 400 is provided to the programmable logic controller 999.

In an embodiment, an airless aqueous iodine scale 401 is connected to the airless iodine product reservoir 900, and measures the weight of the airless aqueous iodine and provides the measurement to the programmable logic controller 999.

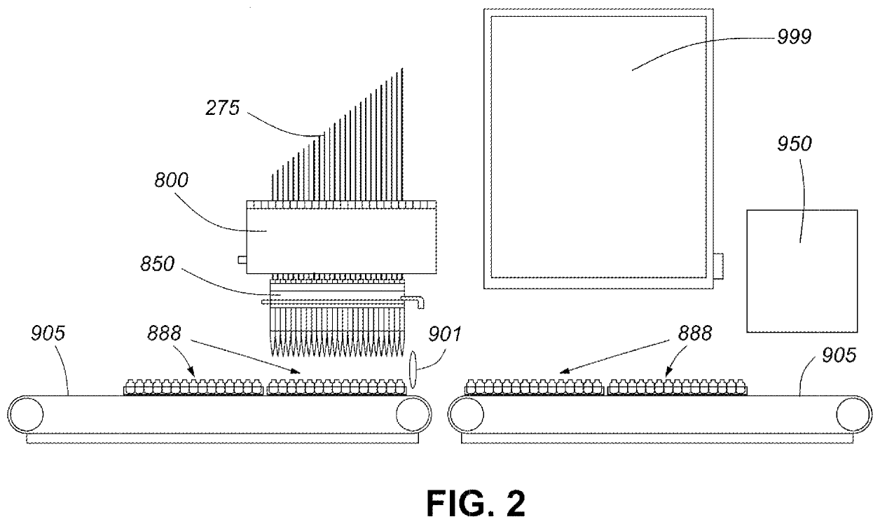

Referring to FIG. 1 and FIG. 2, in a further embodiment, the system includes manifold exit ports (not shown) and transfer pump lines 275, each transfer pump line 275 connected to one of the manifold exit ports. Fill pumps 800 are connected to the transfer pump lines 275 and move airless aqueous iodine from the airless iodine product reservoir 900 through the transfer pump lines 275. Bottles are moved in a fitted jig 888 on a conveyor belt 905 to the transfer pump lines 275 for filling, and a fill line plate system 850 positions the bottles on the conveyor 905 to be filled by the transfer pump lines 275.

In a further embodiment, the system includes a flow sensor/valve B1 on the water bypass line A2. The flow measurements of the flow sensor/valve B1 are sent to the programmable logic controller 999 to regulate a volume controller of water feed line A1 and water bypass line A2. The system further includes a flow sensor B5 on the iodine concentrate supply line A3. The flow measurements of the flow sensor B5 are sent to the programmable logic controller 999 to regulate a volume controller of the water bypass line A2 to the finished aqueous iodine supply line A4.

In a further embodiment, the system includes more than one iodine concentrate supply line 301a, 302a, 303a, 304a, each iodine concentrate supply line connected through an iodine concentrate supply line valve XB to one of the iodine columns 301, 302, 303, 304. This allows for multiple concentrations or batches of iodine concentrate to be produced in parallel.

The sensor 110, 120 for measuring iodine concentration in the aqueous iodine production system may be an in-line electronic sensor and/or an in-line spectrophotometer.

A method for producing airless aqueous iodine includes providing water through a water feed line A1 to a plurality of iodine columns 301, 302, 303, 304 and flowing water through the plurality of iodine columns to produce an iodine concentrate. The iodine concentrate is passed from the iodine columns 301, 302, 303, 304 through an iodine concentrate supply line A3 and filtered through a sediment filter 101. The iodine concentration of the concentrate is adjusted with water from a water bypass line A2 in a finished aqueous iodine supply line A4 to produce an aqueous iodine. The aqueous iodine is passed through a manifold 250 that includes a vacuum system 900a. The vacuum system 900a removes air from the iodine product reservoir 900 while supply line valve XD is shut, thereby providing the airless iodine product reservoir 900. Supply line valve XD is opened to fill the airless iodine product reservoir 900 with the aqueous iodine for storage.

In an embodiment of the method, the iodine concentration is measured in the iodine concentrate supply line using a sensor 110, 120. The sensor 110, 120 is an electronic sensor and/or a spectrophotometer.

The flow of the water through the water feed line A1 is regulated by a water feed line valve XA. The flow of the iodine concentrate through the iodine concentrate supply line A3 is regulated by an iodine concentrate supply line valve XC. The water flow, iodine concentrate flow, and the iodine concentration measurements are received by a programmable logic controller 999. In response, the programmable logic controller 999 controls the water feed line valve XA and the iodine concentrate supply line valve XC to adjust the iodine concentration of the iodine concentrate.

The flow of the water through the water bypass line A2 is measured by a flow sensor/valve B1, connected to the programmable logic controller 999, which in turn regulates flow through the water feed line A1 and the water bypass line A2 through a volume regulator. The flow of the iodine concentrate through the iodine concentrate supply line A3 is measured through a flow sensor B5, connected to the programmable logic controller 999, which in turn regulates flow through the water bypass line A2 and finished aqueous iodine supply line A4 through a volume regulator. In this way, flow of water through the iodine columns 301, 302, 303, 304 is regulated to achieve a target iodine concentration in the iodine concentrate, and to further adjust the iodine concentration of the finished aqueous iodine with water from the water bypass line A2.

In a further embodiment of the method, measuring the iodine concentration includes measuring a weight of the iodine columns 301, 302, 303, 304 using an iodine generator scale 400 connected to an iodine generator box 300 supporting the iodine columns, measuring a weight of the airless aqueous iodine using an airless aqueous iodine scale 401 connected to the airless iodine product reservoir 900, providing the iodine column weight and the airless aqueous iodine weight to the programmable logic controller 999, and calculating the iodine concentration of the airless aqueous iodine by the programmable logic controller using the iodine column weight and the airless aqueous iodine weight.

In a further embodiment, the airless aqueous iodine is drawn from the reservoir 900 through transfer pump lines 275 using a fill pump 800, and from the transfer pump lines 275 to fill bottles with the airless aqueous iodine. The bottles are in a jig 888 provided by a conveyor belt 905 and positioned for filling by a fill line plate system 850.

In an embodiment, multiple iodine concentrate supply lines 301a, 302a 303a, 304a are included, each iodine concentrate supply line connected to one iodine column 301, 302, 303, 304, thereby allowing production of a plurality of concentrations of iodine concentrate.

The production of aqueous iodine using the system may be carried out in more than one location. For example, the iodine columns 301, 302 303, 304 may be in one location, the airless iodine product reservoir 900 may be in another location, and the bottling of the airless aqueous iodine on a conveyor 905 may be in another location.

In a further embodiment, the pH of the iodine concentrate is adjusted using a base injection port 130 and an acid injection port 140 in the iodine concentrate supply line A3. A sample of iodine concentrate may also be removed using a sample port 201 in the iodine concentrate supply line A3.

The present invention provides three different mechanical methods within the iodine production system to accurately assess a known quantity of aqueous iodine being produced and in a finished batch, regardless of environmental conditions. This system also provides unique high flow refillable iodine columns 301, 302 303, 304 within an iodine generator apparatus that can be programmed to produce specific batch lots and species of iodine. This iodine system generator can accommodate different forms and quality of solid iodine concurrently. This iodine generator has vertical iodine columns 301, 302 303, 304 running in parallel allowing for the highest output of aqueous iodine production. This iodine system has a scalable, iodine generator apparatus. An automated programmable logic controller 999 is programmed to operate the complete iodine production and bottling invention and control input water to the iodine apparatus to produce aqueous iodine ready for bottling. The finished aqueous iodine batch lot is produced and is accumulated in an airless reservoir 900 to control the integrity of the finished product. The automated system then activates the bottling component including peristaltic pumps with iodine resistant fill lines to maintain the integrity of the finished aqueous iodine product. A 16 kilogram Iodine generator apparatus as described is capable of bottling in excess of 200,000 bottles of precisely controlled formulated aqueous iodine per hour.

The present invention provides for high flow multiple paralleled iodine columns 301, 302 303, 304, within a pure aqueous iodine generation apparatus, comprising several inline iodine content monitoring systems coupled with unique airless mixing and finished formula aqueous iodine batch reservoirs; capable of sustaining finished batches of aqueous iodine for prolonged periods of time. Unique stackable airless finished batch iodine product reservoirs 900 are directly connected to iodine bottling systems comprising peristaltic pumps with iodine inert fill hoses to maintain product integrity of an airless iodine generation system to the bottling fill point. Airless, traditional glass or plastic bottles are placed and filled within custom acrylic jigs 888 to accommodate the iodine fill lines. The iodine fill lines are located within a horizontal mobile acrylic or the like, plate apparatus 850 accepting the iodine bottle fill lines. This fill line plate 850 is mounted horizontally above a programmed controlled conveyor belt 905 that moves the bottles within the acrylic jigs 888 to mate with the iodine fill lines. This entire process from aqueous iodine production, to finished bottled product is orchestrated by a programmable logic controller 999 with specific input codes to produce and bottle aqueous iodine at predetermined precise programmed formulas without human intervention. This invention does allow for human iodine sampling and intervention within the programming. This system is not affected by environmental conditions, water temperature, or water flow rate.

The present invention is fully automated. Its valved directional water flow dynamics, inline iodine monitoring systems comprising spectrophotometry, electrical current feedback and weights and measures, allows for pure accurate aqueous iodine production and iodine content management within a pure aqueous iodine solution from generation to finished aqueous iodine product batches and lots. This invention responds instantly to environmental changes to ensure aqueous iodine content is known and accurate at all times. This invention provides for a total airless aqueous iodine system from production to the end bottling point ensuring product integrity throughout the process. The embodiment of paralleled sixteen kilogram iodine generation columns invention allows high flow aqueous iodine production, accepting different types, forms and quality of solid iodine to produce aqueous iodine independently in each column or a combination variation of product can be produced. This invention allows for in excess of 30 different aqueous iodine formulations to be produced and bottled simultaneously. The aqueous iodine species and formulations of aqueous iodine generated may be varied and controlled through adjustment product injection points at specific locations within the system. This iodine production and bottling system invention is capable of bottling in excess of 200,000 bottles an hour, per bottling line, with increased expansion capabilities. All the processes are implemented by the programmable logic controller.

An example embodiment is presented below:

Referring again to FIG. 1, the water flight path starts at A1 and splits. One line, the water feed line A1, enters iodine generator box 300, while the second line, water bypass line A2, bypasses the system for a re-blend if necessary. This process is controlled by a solenoid valve, water feedline valve XA. Water enters the iodine generator box 300 and flows through iodine columns 301, 302, 303, 304 in contact with the iodine within the columns. Iodine concentrate supply line valves XB at the top of the iodine columns control the water direction after passing through the iodine columns 301, 302 303, 304. Aqueous iodine concentrate now passes through iodine concentrate supply line A3 and enters a 1 micron filter 101, then passes by an electronic sensor 110 providing an iodine electronic reading converted to content value, then passes through a photo-spectrometry lens 120 to gauge the colour metrics of the solution and create a content value. Then either a base 130 or an acid 140 can be injected into the iodine concentrate, and the iodine concentrate passes through an inline helicoil mixer 150, then a sample port 201, and passes by flow sensor B5 to provide a value. The iodine concentrate then blends with water from water bypass line A2 through a helicoil mixer 150 to create finished the finished formula in aqueous iodine supply line A4. The finished aqueous iodine then passes through sample calibration port 201, followed by Solenoid supply line valve XD, then enters the manifold 250 fitted with exit ports for the transfer pump lines 275 with 900a vacuum system for Airless Aqueous Iodine reservoir 900. Upon filling the reservoir 900, scales 400 and 401 evaluate the content of iodine used from iodine generator box 300 and Airless Aqueous Iodine reservoir 900. All Data Inputs are relayed to programmable logic controller 999 to operate the system and produce predetermined finished formula batches by direct aqueous iodine production or a re-blend with line A2 for adjustments.

Referring to FIG. 2, at this point the programmable logic controller 999 activates and primes fill pumps 800, drawing from batch reservoir 900 to start the bottling process. Bottles are place in a fitted jig 888, and are transported along conveyor belt 905 to a precise filling point on the line determined by light sensor 901. Fill line plate system 850 is pneumatically operated and positioned to fill bottles within jig 888 on conveyor belt 905. Once bottles are filled, the jigs 888 continue on to traditional bottle capping and labeling 950.

Each of the valves within the system controls water direction and flow rates to either enter the iodine generator apparatus, blend it or bypass it. The iodine generator is controlled by multidirectional valves and consists of four columns 301a, 302a, 303a, 304a of iodine that can operate independently or in unison to produce various blends and concentrations of iodine providing different formula outcomes simultaneously. The aqueous iodine solution is verified during production by way of electrical iodine sensing 110, spectrophotometry 120, and weights and measure 400, 401 in the final product. It can also be sampled and tested manually. The final product is held in an airless vessel 900 and then a peristaltic pumps system 800 delivers the aqueous formula from the airless vessel to the liquid bottling line to fill a predetermined volume bottle. On the bottling line special jigs 888 retain the bottles and are transported along a conveyor belt 905 to the precise point of filling. At that time a fill plate containing multiple fill lines is lowered pneumatically to fill the bottles in the jig. The fill plate 850 also contains ventilation to remove any gaseous iodine from the bottling line during production. The bottles are then capped, labelled and boxed to be shipped.

Electronic valves, flow sensors, pressure gauges, electrical iodine readings, photo light readings, weights and measures provide information to the programmable logic controller 999 to accurately produce a predetermined formula by controlling water flows and blending ratios based on actual input values from the sensor arrays within the apparatus.

All of the components to assemble this invention can be purchased. Prior to introducing the programmable logic controller 999 and the online electronic components, start by building the system with manual valves and human sampling ports for product content and verification. Ensure the system is pressurized and airless through to the final end in the aqueous iodine reservoir 900. Utilize peristaltic pumps connected to the airless aqueous iodine reservoirs to bottle an aqueous iodine formula. Once the system is operational and tested, replace the manual valves with appropriate solenoid valves as per the invention. Add the inline iodine content sensing 110, 120 and detection systems, then connect to the programmable logic controller 999 to complete the invention as described.

In an alternative version of the invention, a booster pump on water feed line A1 may be added to account for pressure drops across the iodine generator apparatus to allow for positive pressure blending of water feed line A1 and water bypass line A2 within the overall system. An additional iodine generator apparatus can be added to increase production rates, or additional iodine columns can be added to the iodine column apparatus to increase aqueous iodine production within the overall system.

Another alternative version is the single source water feed line A1 listed in the invention, may also be provided from two separate source water supplies. Iodine generation, aqueous iodine storage and iodine bottling may be done in separate locations. This invention provides for an in system blending of the final product, alternatively the final airless aqueous iodine reservoirs may also be utilized for blending a final product. The iodine generator columns may alternatively be structured in a “series” water flow configuration, but not recommended. The airless iodine reservoirs 900 may also be stackable. The airless iodine reservoirs 900 can also be used to ship or store finished or raw iodine concentrate product for extended periods of time.

With this invention, in excess of thirty different aqueous iodine derivative products can be produced simultaneously, onsite, in any country around the world; for humanitarian, medical, disease, drug applications and more can be produced accurately, inexpensively and in large quantities by this invention. Pure Aqueous Iodine disinfection products, human and animal micronutrients, drugs, agriculture products and more can be made available.

Additionally, this invention is designed to generate and produce a bottle of precise iodine content and formula. The design of the iodine generator apparatus within the invention allows for high production rates and long retention times of pure aqueous iodine for alternative product applications. such as spraying crops and soil, disinfecting livestock drinking water, filling large and small containers with aqueous iodine for various applications.

Also, this invention can alter the biocidal species of aqueous iodine. This invention can convert iodine to its ionic state. This invention can produce multiple iodine product formulas concurrently.

The present invention has been shown and described in a preferred embodiment. It is recognized, however, that departures may be made within the scope of the invention and that obvious modifications will occur to a person skilled in the art. With respect to the above description, it is to be realized that the optimum dimensional relationships for the parts of the presented invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

What is claimed is:

1. A system for airless aqueous iodine production, the system comprising:
a plurality of iodine columns to hold iodine;
a water feed line connected through a water feed line valve to the iodine columns, for providing water to the iodine columns;
a water by-pass line having a first end and a second end,
the first end diverting from the water feed line, for diverting water away from the water feed line; and
the second end connected to a finished aqueous iodine supply line, for supplying water to the finished aqueous iodine supply line;
at least one iodine concentrate supply line connected through an iodine concentrate supply line valve to at least one of the iodine columns, for directing iodine concentrate from the at least one iodine column to the finished aqueous iodine supply line, and comprising a sensor for measuring iodine concentration;
the finished aqueous iodine supply line comprising:
a first end connected to the iodine concentrate supply line and the water bypass line;
an inline mixer for mixing the iodine concentrate with the water from the water bypass line to produce a finished aqueous iodine; and
a second end;
a manifold having
a first end connected to the second end of the finished aqueous iodine supply line through a finished aqueous iodine supply line valve;
a second end connected to an iodine product reservoir, for storing the airless aqueous iodine; and
a vacuum system for removing air from the iodine product reservoir;
a programmable logic controller connected to the water feed line valve, the iodine concentrate supply line valve, and the sensor, for controlling the valves in response to measurements from the sensor.

2. The system of claim 1, further comprising an iodine generator box supporting the iodine columns, an iodine generator scale connected to the iodine generator box, for measuring the weight of the iodine in the iodine columns and providing the measurement to the programmable logic controller.

3. The system of claim 1, further comprising an airless aqueous iodine scale connected to the airless iodine product reservoir, for measuring the weight of the airless aqueous iodine and providing the measurement to the programmable logic controller.

4. The system of claim 1, further comprising:
a plurality of manifold exit ports;
a plurality of transfer pump lines, each transfer pump line connected to one of the manifold exit ports;
a plurality of fill pumps connected to the transfer pump lines for moving airless aqueous iodine from the airless iodine product reservoir through the transfer pump lines;
a conveyor belt for moving bottles to the transfer pump lines for filling; and
a fill line plate system for positioning the bottles on the conveyor to be filled by the transfer pump lines.

5. The system of claim 1, further comprising a flow sensor on at least one of the water bypass line and the iodine concentrate supply line and connected to the programmable logic controller, for measuring the flow of the water and iodine concentrate respectively and sending the measurement to the programmable logic controller.

6. The system of claim 1, wherein the at least one iodine concentrate supply line comprises a plurality of iodine concentrate supply lines, each connected through an iodine concentrate supply line valve to one of the iodine columns.

7. The system of claim 1, wherein the sensor for measuring iodine concentration comprises at least one of:
an in-line electronic sensor for measuring iodine concentration; and
an in-line spectrophotometer for measuring iodine concentration.

8. A method for producing airless aqueous iodine, the method comprising:
providing water through a water feed line to a plurality of iodine columns;
flowing water through the plurality of iodine columns to produce an iodine concentrate;
passing the iodine concentrate through an iodine concentrate supply line;
filtering the iodine concentrate through a sediment filter;
measuring an iodine concentration of the iodine concentrate using a sensor;
adjusting the iodine concentration of the iodine concentrate with water from a water bypass line to produce an aqueous iodine;
passing the aqueous iodine through a manifold comprising a vacuum system to an airless iodine product reservoir for storage of an airless aqueous iodine.

9. The method of claim 8, wherein the iodine concentration is measured using a sensor comprising at least one of an electronic sensor and a spectrophotometer.

10. The method of claim 8, further comprising:
measuring the flow of the water through the water feed line by a water feed line flow sensor;
measuring the flow of the iodine concentrate through the iodine concentrate supply line by an iodine concentrate supply line flow sensor;
receiving the water flow measurement, the iodine concentrate flow measurement, and the iodine concentration measurement by a programmable logic controller; and
controlling a water feed line valve and an iodine concentrate supply line valve by the programmable logic controller to adjust the iodine concentration of the iodine concentrate.

11. The method of claim 9, wherein measuring the iodine concentration further comprises:
measuring a weight of the iodine columns using an iodine generator scale connected to an iodine generator box supporting the iodine columns;
measuring a weight of the airless aqueous iodine using an airless aqueous iodine scale connected to the airless iodine product reservoir;
providing the iodine column weight and the airless aqueous iodine weight to the programmable logic controller; and
calculating the iodine concentration of the airless aqueous iodine by the programmable logic controller using the iodine column weight and the airless aqueous iodine weight.

12. The method of claim 8, further comprising:
drawing the airless aqueous iodine from the reservoir through a plurality of transfer pump lines using a fill pump; and
filling a plurality of bottles with the airless aqueous iodine from the transfer pump lines.

13. The method of claim 12, wherein the plurality of bottles are provided by a conveyor belt and positioned for filling by a fill line plate system.

14. The method of claim 8, wherein the iodine concentrate supply line comprises a plurality of iodine concentrate supply lines, each iodine concentrate supply line connected to one iodine column, thereby providing a plurality of concentrations of iodine concentrate.

15. The method of claim 8, wherein the flowing water through the plurality of iodine columns to produce an iodine concentrate, the passing the aqueous iodine to an airless iodine product reservoir for storage and the filling a plurality of bottles with the airless aqueous iodine are at more than one location.

16. The method of claim 8, further wherein a pH of the iodine concentrate is adjusted using a base injection port and an acid injection port in the iodine concentrate supply line.

17. The method of claim 8, further comprising removing a sample of iodine concentrate using a sample port in the iodine concentrate supply line.
